(19) United States
(12) Patent Application Publication
(10) Pub. No.: US 2025/0392009 A1
(43) Pub. Date: Dec. 25, 2025

(54) BUSBAR MODULE

(71) Applicant: Yazaki Corporation, Tokyo (JP)

(72) Inventors: Takafumi Saito, Shizuoka (JP); Ryota Ando, Shizuoka (JP)

(21) Appl. No.: 19/211,455

(22) Filed: May 19, 2025

(30) Foreign Application Priority Data
Jun. 19, 2024 (JP) 2024-099029

(51) Int. Cl. H01M 50/507; H01M 50/519

(52) U.S. Cl. CPC H01M 50/507; H01M 50/519

(57) ABSTRACT

A busbar module includes a case, busbars, a circuit body, and a cover. The case includes busbar accommodating row portions in which a plurality of busbar accommodating portions are connected to each other by coupling members, and are arranged in two rows, and support plate members each of which connecting one busbar accommodating portion and the other busbar accommodating portion to each other, and a plurality of locking portions locking the cover. Each of a plurality of block bodies constituted by a pair of the busbar accommodating portions connected to each other by the support plate member is provided with one of the locking portions, the locking portions being arranged on the busbar accommodating portions in one row or the other busbar accommodating portions in the other row so as not to be adjacent to each other along the stacking direction.

### CROSS-REFERENCE TO RELATED APPLICATIONS

This application is based on and claims priority under 35 USC 119 from Japanese Patent Application No. 2024-099029 filed on Jun. 19, 2024, the entire content of which is incorporated herein by reference.

### TECHNICAL FIELD

The present disclosure relates to a busbar module.

### BACKGROUND ART

A power supply device mounted on various vehicles such as an electric automatic vehicle that travels using an electric motor and a hybrid automatic vehicle that travels using both an engine and an electric motor includes a busbar module. The busbar module includes a plurality of busbars respectively connected to electrodes of a plurality of single cells.

A busbar module described in JP2020-13767A includes busbars, a circuit body, a holder (case), and a cover. The busbars are respectively connected to electrodes of a plurality of single cells. The circuit body is formed of a flexible substrate provided with wiring patterns that are electrically connected to the busbars to detect a voltage of the single cells. The holder holds the busbar and is able to expand and contract along a stacking direction of the plurality of single cells. The cover is assembled to the holder to protect the circuit body and the holder.

The circuit body includes a strip-shaped main line extending along the stacking direction and a strip-shaped branch line extending to branch from the main line. At least a part of the branch line includes a folded portion and a connection portion. The connection portion is attached to the busbar at a location closer to a distal end side than the folded portion.

Therefore, since at least a part of the branch line includes the folded portion, when a battery assembly expands and contracts in the stacking direction due to thermal deformation of each single cell, the busbar can move in the stacking direction of the single cells by bending and stretching the folded portion of the branch line of the circuit body. Similarly, by bending and stretching the folded portion of the branch line of the circuit body, a variation in a size of the battery assembly in the stacking direction due to an assembly tolerance of the single cells can be absorbed.

That is, in the busbar module, the main line of the circuit body does not need to be deformed at all, and it is possible to easily cope with the expansion and contraction and the manufacturing variation of the battery assembly by substantially deforming only the branch line.

In the busbar module described above, when the holder is assembled to the battery assembly in which the plurality of single cells are stacked, the holder is deformed in a wavy manner along a longitudinal direction, and thus a positional deviation between the holder and each single cell (electrode) occurs, which may hinder an assembling work.

That is, the holder is configured to be able to expand and contract along the stacking direction of the single cells by connecting, respectively using extendable portions (coupling members), a plurality of busbar accommodating portions each of which accommodates the busbar. Deformation at the extendable portions easily occurs. In particular, in the circuit body pressed to a holder side by the cover, a reaction force of the folded portion provided in a part of the branch line of the flexible substrate is applied to a seat surface of the connection portion for the busbar, and thus the extendable portion is easily deformed.

In order to prevent such deformation of the holder, it is desirable that all the busbar accommodating portions are provided with locking portions that are engaged with engaging portions provided on the cover to lock the cover, and all the busbar accommodating portions are held by the cover assembled to the holder.

However, when the locking portions that lock the cover are provided in all the busbar accommodating portions, a large number of engaging portions need to be respectively engaged with a large number of locking portions when the cover is assembled, and there is a problem in that the number of work steps performed by a worker increases.

The present disclosure is made in view of the above circumstances, and an object of the present disclosure is to provide a busbar module capable of preventing deformation of a case without increasing the number of work steps for assembling the cover.

### SUMMARY OF INVENTION

The above object of the present disclosure is achieved by the following configuration.

A busbar module includes a case configured to be assembled to a battery assembly in which a plurality of single cells are stacked, busbars configured to be supported by the case and connected to electrodes of the single cells in the battery assembly, a circuit body including a flexible substrate having wiring patterns configured to be electrically connected to the busbars, respectively, and a cover configured to be assembled to the case to protect the circuit body. The case includes busbar accommodating row portions in which a plurality of busbar accommodating portions configured to accommodate the busbars are connected to each other by coupling members that are able to expand and contract, and are arranged in two rows along a stacking direction of the single cells, support plate members each of which is configured to connect the busbar accommodating portion in one busbar accommodating row portion and the busbar accommodating portion in the other busbar accommodating row portion to each other, and a plurality of locking portions configured to lock the cover by being respectively engaged with a plurality of engaging portions provided on the cover. Each of a plurality of block bodies constituted by a pair of the busbar accommodating portions connected to each other by the support plate member is provided with one of the locking portions, the locking portions being arranged on the busbar accommodating portions in one row or the other busbar accommodating portions in the other row so as not to be adjacent to each other along the stacking direction.

According to the present disclosure, it is possible to provide the busbar module capable of preventing deformation of the case without increasing the number of work steps for assembling the cover.

The present disclosure is briefly described above. Further, details of the present disclosure can be clarified by reading a mode (hereinafter, referred to as an “embodiment”) for carrying out the disclosure to be described below with reference to the accompanying drawings.

### BRIEF DESCRIPTION OF DRAWINGS

FIG. 1 is an overall perspective view of a busbar module according to an embodiment of the present disclosure;

FIG. 2 is an exploded perspective view in which a part of the busbar module shown in FIG. 1 is enlarged;

FIG. 3 is a perspective view of a part of a circuit body shown in FIG. 2 as viewed from below;

FIG. 4 is a plan view of a case and a cover of the busbar module according to the present embodiment;

FIG. 5 is an enlarged view of a portion A of the cover shown in FIG. 4;

FIG. 6 is an enlarged view of a portion B of the cover shown in FIG. 4;

FIG. 7 is a cross-sectional view of a main part showing a locking portion of the case which is engaged with an engaging portion of the cover; and

FIG. 8 is a cross-sectional view of a main part showing a state in which a connection portion provided at a distal end of a branch line branched from a main line of the circuit body is attached to the busbar.

### DESCRIPTION OF EMBODIMENTS

Hereinafter, an embodiment according to the present disclosure will be described with reference to the drawings.

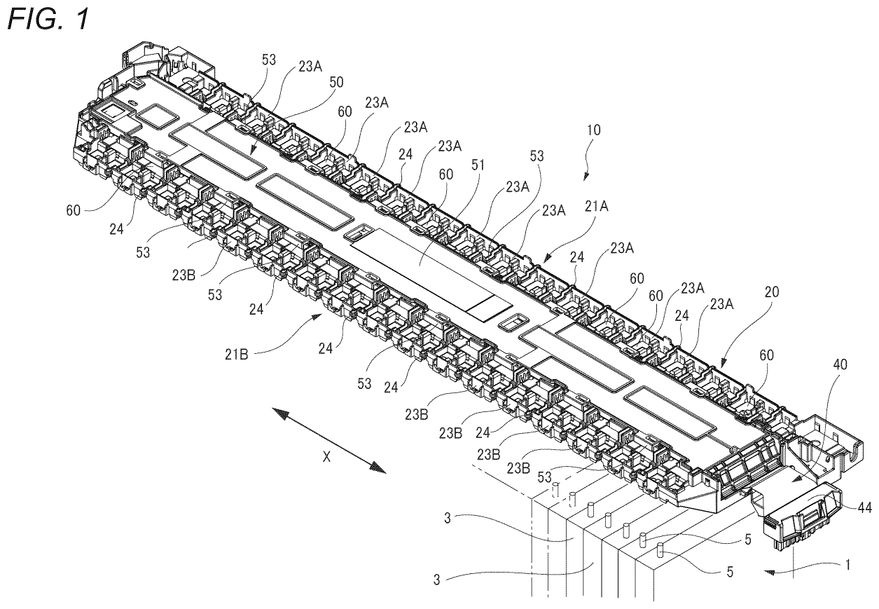

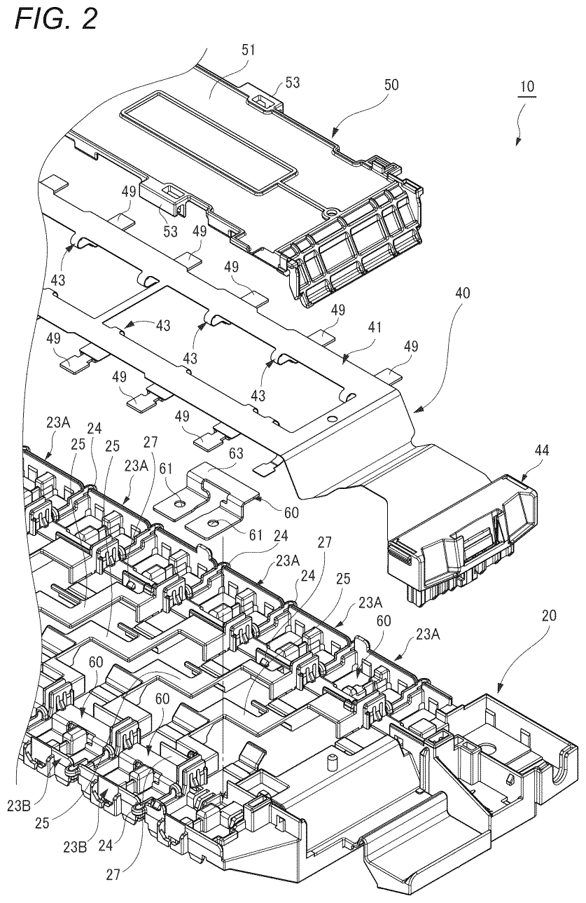

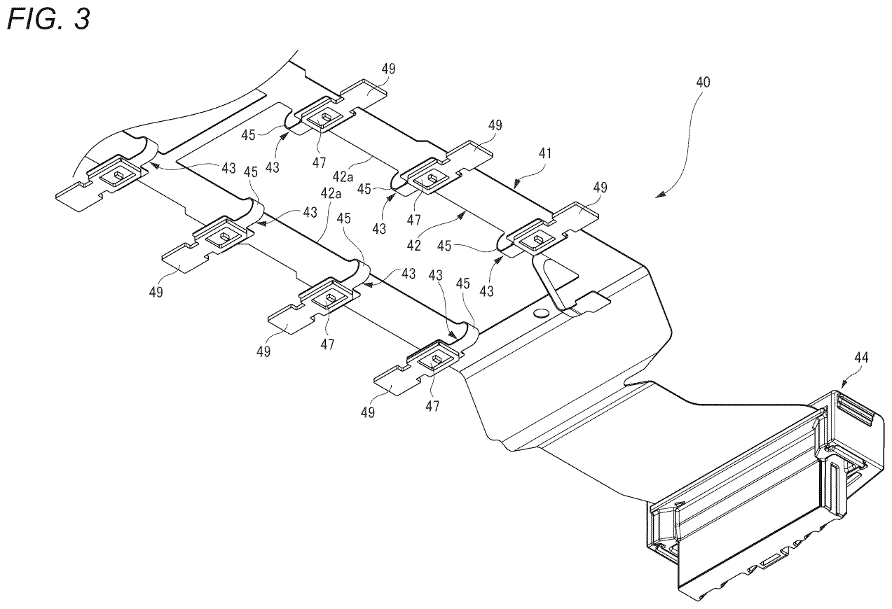

FIG. 1 is an overall perspective view of a busbar module according to an embodiment of the present disclosure. FIG. 2 is an exploded perspective view in which a part of the busbar module shown in FIG. 1 is enlarged. FIG. 3 is a perspective view of a part of a circuit body shown in FIG. 2 as viewed from below.

As shown in FIGS. 1 to 3, a busbar module 10 according to the present embodiment includes a case 20, a plurality of busbars 60, a circuit body 40, and a cover 50. The case 20 is assembled to a battery assembly 1. The plurality of busbars 60 are supported by the case 20. The circuit body 40 includes a flexible substrate (FPC) having wiring patterns that are electrically connected to the busbars 60, respectively. The cover 50 is assembled to the case 20 to protect the circuit body 40.

The busbar module 10 is assembled to an upper portion of the battery assembly 1 to constitute a power supply device. The power supply device is mounted and used in various vehicles such as an electric automatic vehicle that travels using an electric motor and a hybrid automatic vehicle that travels using both an engine and an electric motor, and supplies power to the electric motor.

The battery assembly 1 is an assembled battery including a plurality of single cells 3 that are stacked in a row along one direction. Each of the single cells 3 is formed in a rectangular parallelepiped shape, and includes a pair of electrodes 5 provided to respectively protrude from one end and the other end of an upper face. One of the pair of electrodes 5 is a positive electrode, and the other is a negative electrode.

In the battery assembly 1, poles of the electrodes 5 of the single cells 3 adjacent to each other are aligned. The busbar module 10 connects the plurality of single cells 3 in series by the busbars 60.

As shown in FIGS. 2 and 3, the circuit body 40 according to the present embodiment includes a strip-shaped main line 41 that is disposed on the single cells 3 along a stacking direction X and has wiring patterns (voltage detection lines) electrically connected to the busbar 60, respectively. A connector 44 that connects the voltage detection lines drawn from the main line 41 to a voltage detection device (not shown) is attached to an end of the main line 41.

Strip-shaped branch lines 43 extending in a direction intersecting a longitudinal direction of the main line 41 are provided on both opening edges 42a extending in the 5 longitudinal direction in each of a plurality of rectangular openings 42. The openings 42 are formed in a central portion in a width direction of the main line 41 along the stacking direction X. The branch line 43 extends from the opening edge 42a to branch from the main line 41, and includes, at a part, a folded portion 45 folded downwardly toward the outside in the width direction of the main line 41. The main line 41 and the branch lines 43 are formed 10 of the FPC, and thus the main line 41 and the branch lines 43 can be flexibly deformed particularly in a direction orthogonal to each surface.

A connection portion 47 to be attached to the busbar 60 is provided on a lower face of a distal end of the branch line 43 folded downward by the folded portion 45. The connection portion 47 is attached to the busbar 60 via a flat plate-shaped terminal 49 that is 15 electrically connected to the busbar 60.

The busbar 60 according to the present embodiment is a plate-shaped member made of conductive metal and connected to the electrodes 5 of the single cells 3 in the battery assembly 1. As shown in FIG. 2, the busbar 60 is provided with two electrode holes 61, 61 and a terminal connection portion 63. The electrodes 5, 5 of the adjacent single cells 3 pass 20 through the two electrode holes 61, 61, respectively. The terminal 49 attached to the distal end of the branch line 43 is electrically connected to the terminal connection portion 63.

The case 20 according to the present embodiment is integrally formed of, for example, an insulating synthetic resin or the like. The case 20 includes busbar accommodating row portions 21A and 21B in which a plurality of busbar accommodating portions 23A and 25 23B accommodating the busbars 60 are arranged in two rows along the stacking direction X of the single cells.

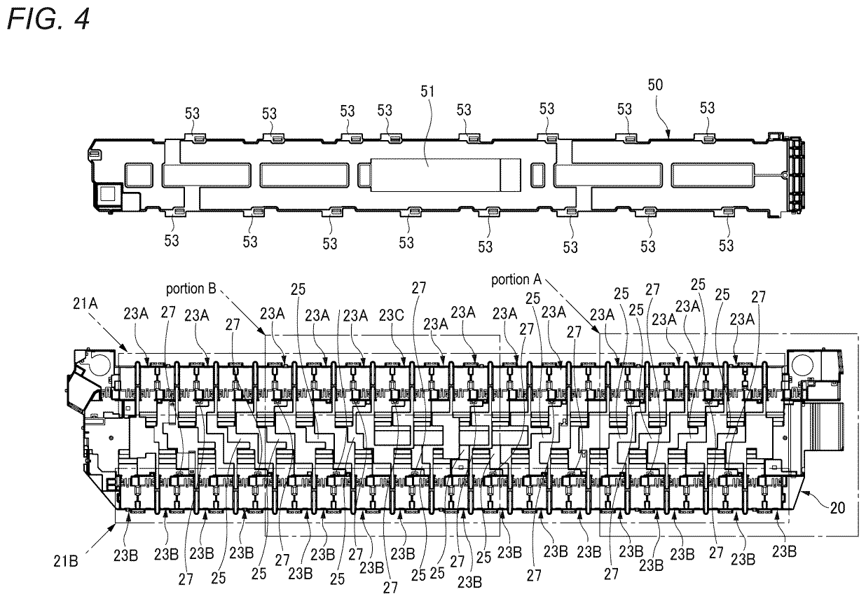

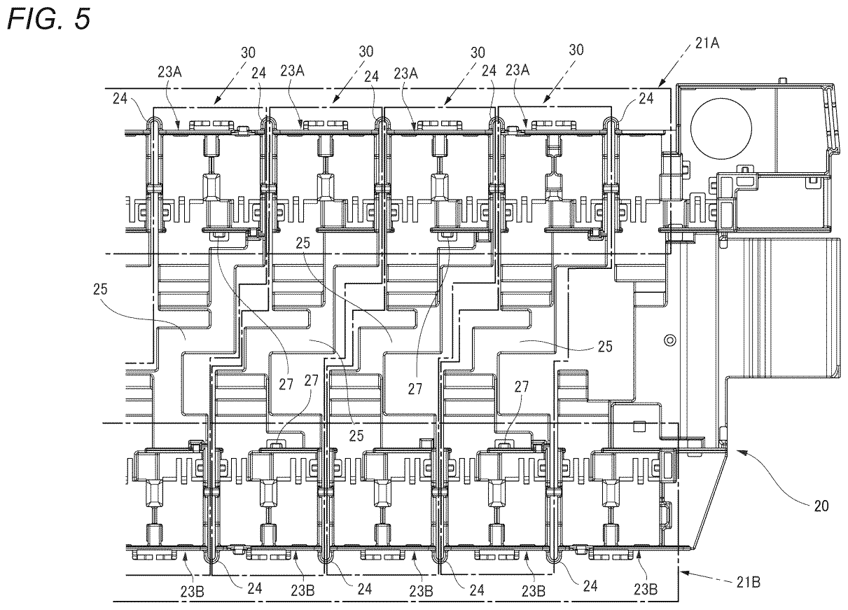

As shown in FIGS. 4 to 6, the case 20 includes a plurality of support plate members 25 and a plurality of locking portions 27. Each of the support plate members 25 connects the busbar accommodating portion 23A in the busbar accommodating row portion 21A and the 30 busbar accommodating portion 23B in the busbar accommodating row portion 21B to each other. The locking portions 27 lock the cover 50 by being respectively engaged with a plurality of engaging portions 53 provided on the cover 50.

The plurality of busbar accommodating portions 23A (23B) arranged in a row along the stacking direction X of the single cells are coupled to each other by coupling members 24 that are able to expand and contract.

The coupling member 24 is a hinge having a semi-cylindrical shape with a C-shaped cross section and formed to be elastically deformable. A pair of edge portions of the coupling member 24 are respectively connected to facing peripheral wall portions of the busbar accommodating portions 23A (23B) that are adjacent to each other. The coupling member 24 is elastically deformed to reduce or increase a distance between the adjacent busbar accommodating portions 23A (23B), thereby absorbing shape errors of the single cell 3, the case 20, and the like. This absorption action can improve assemblability of the power supply device.

The support plate member 25 according to the present embodiment is formed in a crank shape that is able to expand and contract in a direction intersecting the stacking direction X. The support plate member 25 and the pair of busbar accommodating portions 23A and 23B connected to each other by the support plate member 25 constitute each of a plurality of block bodies 30.

The plurality of locking portions 27 according to the present embodiment are respectively engaged with the plurality of engaging portions 53 provided on both side portions in the longitudinal direction of the cover 50 described later. Therefore, each of the block bodies 30 is provided with one locking portion 27, and the locking portions 27 provided on the block bodies 30 are arranged on the busbar accommodating portions 23A in one row or the busbar accommodating portions 23B in the other row so as not to be adjacent to each other along the stacking direction X.

That is, each of the block bodies 30 is provided with one locking portion 27, and the plurality of locking portions 27 are arranged in a staggered pattern along the stacking direction X by being arranged on the busbar accommodating portions 23A in one row or the busbar accommodating portions 23B in the other row so as not to be adjacent to each other along the stacking direction X. The block body 30 has increased rigidity by connecting the pair of busbar accommodating portions 23A and 23B to each other by the support plate member 25.

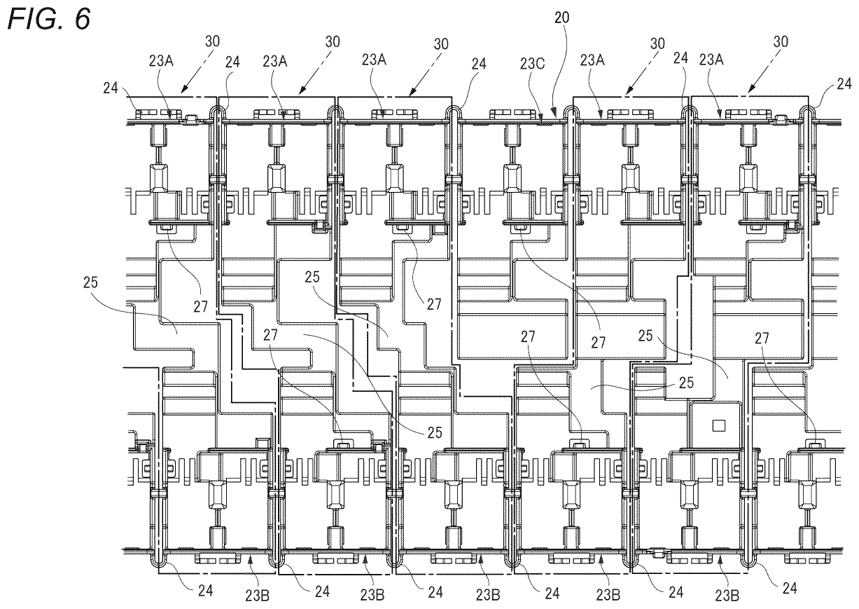

As shown in FIG. 6, depending on a structure of the case 20, a single busbar accommodating portion 23C that cannot constitute the block body 30 with the support plate member 25 is formed in an intermediate portion of the case 20 in the longitudinal direction. Therefore, one locking portion 27 is provided on the single busbar accommodating portion 23C to which the support plate member 25 is not connected.

The main line 41 of the circuit body 40 is routed along the longitudinal direction above the plurality of support plate members 25 that are arranged on a central portion in the width direction of the two busbar accommodating row portions 21A and 21B. The circuit body 40 according to the present embodiment may or may not be supported by the support plate member 25 when each of the main line 41 and the branch lines 43 have a strength capable of maintaining a self-standing state.

The cover 50 according to the present embodiment is integrally formed of, for example, an insulating synthetic resin or the like. As shown in FIG. 2, the cover 50 is assembled to the case 20 accommodating the circuit body 40 from above to cover the circuit body 40 in order to protect the circuit body 40. In a state in which the cover 50 is assembled to the case 20, the connector 44 attached to an end portion of the circuit body 40 is exposed to the outside from a space covered by the case 20 and the cover 50 (see FIG. 1).

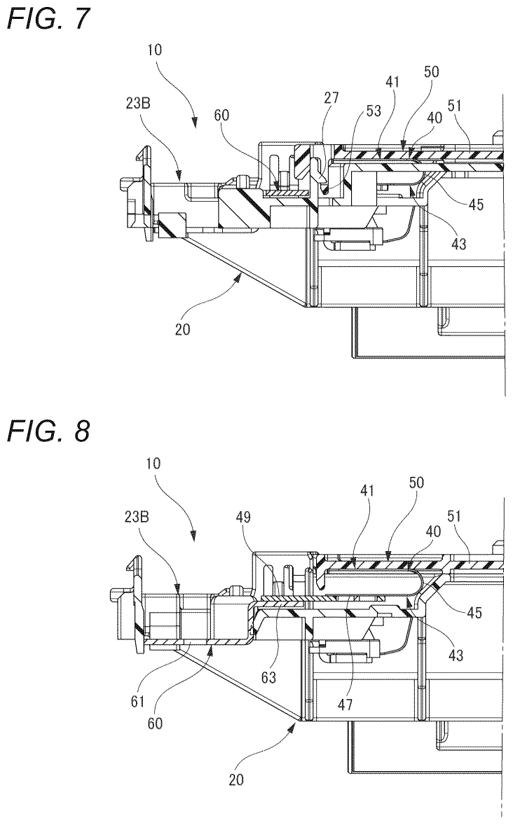

As shown in FIG. 4, the cover 50 includes a top plate portion 51 having a rectangular flat plate shape and the plurality of engaging portions 53 provided on both side portions of the top plate portion in the longitudinal direction. Therefore, as shown in FIG. 7, the cover 50 is assembled to the case 20 by respectively engaging the locking portions 27 of the case 20 with the engaging portions 53 of the cover 50.

At this time, in the circuit body 40 pressed toward the case 20 by the cover 50, as shown in FIG. 8, a reaction force of the folded portion 45 that is provided in the part of the branch line 43 formed of the FPC is applied to a seat surface (lower face) of the terminal 49 with respect to the busbar 60. The reaction force of the folded portion 45 is also applied to corresponding one of the busbar accommodating portions 23A and 23B accommodating the busbars 60.

Here, the locking portion 27 of the case 20 is provided on the block body 30 which has the increased rigidity by connecting the pair of busbar accommodating portions 23A and 23B to each other by the support plate member 25. Therefore, in the busbar module 10 according to the present embodiment, the busbar accommodating portions 23A and 23B can be held via the block body 30 by the cover 50 assembled to the case 20.

In the busbar module 10 according to the present embodiment, each of the block bodies 30 having the increased rigidity is provided with one locking portion 27 of the case 20 to be engaged with the engaging portion 53 of the cover 50. The number of the engaging portions 53 of the cover 50 to be engaged with the locking portions 27 of the case 20 can be reduced by half as compared with a case in which the locking portions 27 are provided on all the busbar accommodating portions 23A and 23B.

As a result, according to the busbar module 10 according to the present embodiment, the number of work steps for assembling the cover 50 can be reduced.

Therefore, according to the busbar module 10 according to the present embodiment, the plurality of locking portions 27 of the case 20 arranged in the staggered pattern along the stacking direction X to lock the cover 50 hold the busbar accommodating portions 23A and 23B via the block bodies 30, and thus it is possible to prevent deformation of the coupling member 24 connecting between the busbar accommodating portions 23A and 23A and between the busbar accommodating portions 23B and 23B, and to prevent the case 20 from being deformed in a wavy manner along the longitudinal direction.

As a result, when the busbar module 10 is assembled to the battery assembly 1, a positional deviation between the case 20 and each single cell 3 (electrode 5) is unlikely to occur, and an assembling work is unlikely to be hindered.

In the busbar module 10 according to the present embodiment, the circuit body 40 includes the strip-shaped main line 41, the strip-shaped branch lines 43, and the connection portions 47. The strip-shaped main line 41 is disposed to extend along the stacking direction. Each of the strip-shaped branch line 43 extends from the main line 41 to branch from the main line 41 and includes the folded portion 45 in at least a part thereof. The connection portion 47 is provided at the distal end portion of the branch line 43 and is to be attached to the busbar 60.

Therefore, when each single cell 3 repeatedly expands and contracts in a thickness direction (stacking direction) or when a position of the single cell 3 varies for each manufactured battery assembly 1 due to an assembly tolerance of the single cell 3, the folded portion 45 of the branch line 43 bends or stretches, so that the busbar 60 can move in the thickness direction of the single cell 3. That is, in the busbar module 10, the main line 41 of the circuit body 40 does not need to be deformed at all, and it is possible to easily cope with expansion and contraction and a manufacturing variation of the battery assembly 1 by substantially deforming only the branch line 43.

When the cover 50 is assembled to the case 20, in the circuit body 40 pressed toward the case 20 by the cover 50, the reaction force of the folded portion 45 provided in the part of the branch line 43 is applied to the busbar 60. The reaction force of the folded portion 45 is also applied to corresponding one of the busbar accommodating portions 23A and 23B accommodating the busbars 60. However, in the busbar module 10, since the busbar accommodating portions 23A and 23B are held via the block body 30, which has the increased rigidity, by the cover 50 assembled to the case 20 as described above, it is possible to prevent the deformation of the coupling member 24, and to prevent the deformation of the case 20.

In the busbar module 10 according to the present embodiment, the support plate member 25 of the case 20 is formed in the crank shape that is able to expand and contract in the direction intersecting the stacking direction X. Therefore, when each single cell 3 repeatedly expands and contracts in the width direction (direction intersecting the stacking direction), the support plate member 25 formed in the crank shape expands and contracts, and thus each of the busbar accommodating portions 23A, 23B can move in the width direction of the single cell 3. That is, the case 20 can easily cope with the expansion and contraction in the width direction and a manufacturing variation of the single cell 3.

In the busbar module 10 according to the present embodiment, one locking portion 27 is provided on the busbar accommodating portion 23C to which the support plate member 25 is not connected. Therefore, even in the structure of the case 20 in which the single busbar accommodating portion 23C that cannot constitute the block body 30 with the support plate member 25 is formed in the intermediate portion of the case 20 in the longitudinal direction, the busbar accommodating portion 23C can be held by the engaging portion 53 of the cover 50 assembled to the case 20.

The present disclosure is not limited to the embodiment described above, and can be appropriately modified, improved, or the like. In addition, materials, shapes, sizes, numbers, arrangement positions, and the like of components in the embodiments described above are freely selected and are not limited as long as the present disclosure can be implemented.

Here, features of the embodiment described above of the busbar module according to the present disclosure will be briefly summarized and listed in the following [1] to [4]. [1] A busbar module (10) including:
a case (20) configured to be assembled to a battery assembly (1) in which a plurality of single cells (3) are stacked;
busbars (60) configured to be supported by the case (20) and connected to electrodes (5) of the single cells (3) in the battery assembly (1);
a circuit body (40) including a flexible substrate having wiring patterns configured to be electrically connected to the busbars (60), respectively; and
a cover (50) configured to be assembled to the case (20) to protect the circuit body (40), in which
the case (20) includes:
busbar accommodating row portions (21A, 21B) in which a plurality of busbar accommodating portions (23A, 23B, 23C) configured to accommodate the busbars (60) are connected to each other by coupling members (24) that are able to expand and contract, and are arranged in two rows along a stacking direction of the single cells (3);
support plate members (25) each of which is configured to connect the busbar accommodating portion (23A) in one busbar accommodating row portion (21A) and the busbar accommodating portion (23B) in the other busbar accommodating row portion (21B) to each other; and
a plurality of locking portions (27) configured to lock the cover (50) by being respectively engaged with a plurality of engaging portions (53) provided on the cover (50), and
each of a plurality of block bodies (30) constituted by a pair of the busbar accommodating portions (23A, 23B) connected to each other by the support plate member (25) is provided with one of the locking portions (27), the locking portions (27) being arranged on the busbar accommodating portions (23A) in one row or the other busbar accommodating portions (23B) in the other row so as not to be adjacent to each other along the stacking direction (X).

According to the busbar module (10) having the configuration of the above [1], each of the block bodies (30) having the increased rigidity is provided with one locking portion (27) of the case (20) to be engaged with the engaging portion (53) of the cover (50). The number of the engaging portions (53) of the cover (50) to be engaged with the locking portions (27) of the case (20) can be reduced by half as compared with the case in which the locking portions (27) are provided in all the busbar accommodating portions (23A, 23B).

The plurality of locking portions (27) of the case (20) arranged in the staggered pattern along the stacking direction (X) to lock the cover (50) hold the busbar accommodating portions (23A, 23B) via the block bodies 30, and thus it is possible to prevent deformation of the coupling member (24) connecting between the busbar accommodating portions (23A, 23A) and between the busbar accommodating portions (23B, 23B), and to prevent the case (20) from being deformed in a wavy manner along the longitudinal direction.
[2] The busbar module (10) according to the above [1], in which
the circuit body (40) includes:
a strip-shaped main line (41) configured to be disposed to extend along the stacking direction (X);
strip-shaped branch lines (43) each of which extends from the main line (41) to branch from the main line (41) and includes a folded portion (45) in at least a part of the strip-shaped branch line (43); and
connection portions (47) each of which is provided at a distal end of the branch line (43) and is configured to be attached to corresponding one of the busbars (60).

According to the busbar module (10) having the configuration of the above [2], the main line (41) of the circuit body (40) does not need to be deformed at all, and it is possible to easily cope with the expansion and contraction and the manufacturing variations of the battery assembly (1). by substantially deforming only the branch line (43).

When the cover (50) is assembled to the case (20), in the circuit body (40) pressed toward the case (20) by the cover (50), the reaction force of the folded portion (45) provided in the part of the branch line (43) is applied to corresponding one of the busbar accommodating portions (23A, 23B) accommodating the busbars (60). However, since the busbar accommodating portions (23A, 23B) are held via the block body (30), which has the increased rigidity, by the cover (50) assembled to the case (20), it is possible to prevent the deformation of the coupling member (24), and to prevent the deformation of the case (20).
[3] The busbar module (10) according to the above [1], in which
the support plate member (25) is formed in a crank shape that is able to expand and contract in a direction intersecting the stacking direction (X).

According to the busbar module (10) having the configuration of the above [3], when each single cell (3) repeatedly expands and contracts in the width direction (direction intersecting the stacking direction (X)), the support plate member (25) formed in the crank shape expands and contracts, and thus each of the busbar accommodating portions (23A, 23B) can move in the width direction of the single cell (3). That is, the case (20) can easily cope with the expansion and contraction in the width direction and the manufacturing variation of the single cell (3).
[4] The busbar module (10) according to any one of the above [1] to [3], in which one of the locking portions (27) is provided on the busbar accommodating portion (23C) to which the support plate member (25) is not connected.

According to the busbar module (10) having the configuration of the above [4], even in the structure of the case (20) in which the single busbar accommodating portion (23C) that cannot constitute the block body (30) with the support plate member (25) is formed in the intermediate portion of the case (20) in the longitudinal direction, the busbar accommodating portion (23C) can be held by the engaging portion (53) of the cover (50) assembled to the case (20).

What is claimed is:

1. A busbar module comprising:
a case configured to be assembled to a battery assembly in which a plurality of single cells are stacked;
busbars configured to be supported by the case and connected to electrodes of the single cells in the battery assembly;
a circuit body including a flexible substrate having wiring patterns configured to be electrically connected to the busbars, respectively; and
a cover configured to be assembled to the case to protect the circuit body, wherein
the case includes:
busbar accommodating row portions in which a plurality of busbar accommodating portions configured to accommodate the busbars are connected to each other by coupling members that are able to expand and contract, and are arranged in two rows along a stacking direction of the single cells;
support plate members each of which is configured to connect the busbar accommodating portion in one busbar accommodating row portion and the busbar accommodating portion in the other busbar accommodating row portion to each other; and
a plurality of locking portions configured to lock the cover by being respectively engaged with a plurality of engaging portions provided on the cover, and
each of a plurality of block bodies constituted by a pair of the busbar accommodating portions connected to each other by the support plate member is provided with one of the locking portions, the locking portions being arranged on the busbar accommodating portions in one row or the other busbar accommodating portions in the other row so as not to be adjacent to each other along the stacking direction.

2. The busbar module according to claim 1, wherein
the circuit body includes:
a strip-shaped main line configured to be disposed to extend along the stacking direction;
strip-shaped branch lines each of which extends from the main line to branch from the main line and includes a folded portion in at least a part of the strip-shaped branch line; and
connection portions each of which is provided at a distal end of the branch line and is configured to be attached to corresponding one of the busbars.

3. The busbar module according to claim 1, wherein
the support plate member is formed in a crank shape that is able to expand and contract in a direction intersecting the stacking direction.

4. The busbar module according to claim 1, wherein
one of the locking portions is provided on the busbar accommodating portion to which the support plate member is not connected.
